(19) United States
(12) Patent Application Publication
(10) Pub. No.: US 2023/0401099 A1
(43) Pub. Date: Dec. 14, 2023

(54) ATTRIBUTES FOR WORKLOADS, INFRASTRUCTURE, AND DATA FOR AUTOMATED EDGE DEPLOYMENT

(71) Applicant: Dell Products L.P., Round Rock, TX (US)

(72) Inventors: Eric Bruno, Shirley, NY (US); Victor Fong, Medford, MA (US); Amy N. Seibel, Newton, MA (US)

(21) Appl. No.: 17/806,857

(22) Filed: Jun. 14, 2022

(51) Int. Cl. G06F 9/50; G06F 9/48

(52) U.S. Cl. CPC G06F 9/505; G06F 9/4875

(57) ABSTRACT

Attribute-based workload placement and orchestration in a computing environment including nodes is disclosed. A workload, when received at a scheduling engine, is given a workload score determined from the workload's attributes. Using the workload attributes, along with node attributes and/or data attributes, the workload is placed with one of the nodes. The node is selected based on how the workload attributes compare with the node attributes and/or the data attributes and based on the node score.

### RELATED APPLICATIONS

This application relates to U.S. Ser. No 17/682,256, filed Mar. 3, 2022, which application is incorporated by reference in its entirety.

### FIELD OF THE INVENTION

Embodiments of the present invention generally relate to automated deployment. More particularly, at least some embodiments of the invention relate to systems, hardware, software, computer-readable media, and methods for attribute-based workload deployment and orchestration in a distributed deployment.

### BACKGROUND

In addition to an increased need for computing resources, there is also a need to have workloads performed or executed more efficiently and effectively. The need for computing resources coincides with increased software complexity, expanding data volumes, and digital transformations. Deploying and managing these systems is a very complex process. In fact, it is impractical, expensive, and inefficient to manually define these deployments.

More specifically, it is difficult to measure, quantify, and advertise the static and dynamic nature of infrastructure available in a distributed system. Consequently, the best location to run applications and associated workloads is difficult to identify. Even if workloads happen to be deployed to an adequate infrastructure, there is no assurance that another infrastructure would be better. Part of the problem is that the requirements of a workload are often expressed in different ways and are difficult to match with infrastructure capabilities.

In addition to difficulties in understanding the status of distributed hardware resources and workload requirements, the data may also impact the efficiency of the workload. Data can vary, for example, in terms of provenance, quality, confidence, volume, arrival rates, staleness, or the like. The complexity of deploying, operating, and orchestrating workloads continues to increase, and this complexity may adversely impact efficiencies, performance, and cost.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a scheduling engine configured to perform attribute-based placement and orchestration;

FIG. 2 discloses aspects of an environment in which workloads are placed and orchestrated;

FIG. 3 discloses aspects of acquiring and using node attributes in placing and orchestrating workloads;

FIG. 4 discloses aspects of placing a workload in a distributed system;

FIG. 5 discloses aspects of collecting node attributes;

FIG. 6 discloses aspects of processing node attributes;

FIG. 7 discloses aspects of attribute-based workload deployment and orchestration including workload migration; and

FIG. 8 discloses aspects of a computing device, system, or entity.

### DETAILED DESCRIPTION OF SOME EXAMPLE EMBODIMENTS

Embodiments of the present invention generally relate to attribute-based workload deployment in computing systems. More particularly, at least some embodiments of the invention relate to systems, hardware, software, computer-readable media, and methods for deploying workloads across a computing spectrum based on workload attributes, infrastructure attributes, and/or data attributes.

In general, example embodiments of the invention relate to measuring attributes including the compute, storage and network capacity of infrastructure at different points of a computing network or system in a standard manner. In addition, a standardized method is disclosed for measuring or quantifying attributes of workloads and/or data used or consumed by the workloads. These attributes allow a scheduler to automatically deploy (and/or redeploy/migrate) workloads in a manner that accounts for the attributes of the infrastructure, the workloads, and/or the data.

A system or collection of attributes are disclosed that describe the capabilities of infrastructure, the requirements of workloads, and the qualities of data and their sources. These attributes can be organized into various forms such as a policy, a manifest, an XML (Extensible Markup Language) document, JSON (JavaScript Object Notation) format, or the like.

When a workload is received, embodiments of the invention process the various attributes to determine a suitable infrastructure for performing the workload. This may include comparing and matching these sets of attributes. Comparing and matching the infrastructure attributes, the workload attributes, and/or the data attributes allows a scheduler to automate the placement of workloads across a distributed edge computing environment by selecting a suitable infrastructure for the workload and deploying the workload to the selected infrastructure. In addition, as some of the attributes change, workloads may be migrated from one infrastructure to another infrastructure.

Embodiments of the invention relate to a declarative model of infrastructure, workloads, and data that enable computing environments such as edge systems to self-deploy and self-maintain an optimized system state.

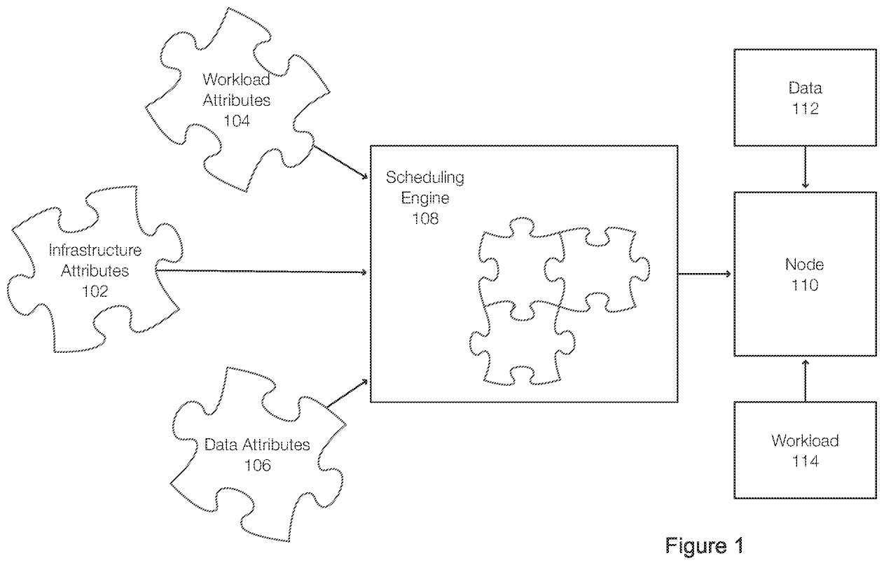

FIG. 1 discloses aspects of automating the placement of workloads based on hierarchical sets of attributes that describe the capabilities of infrastructure (dynamic and static), the needs of services, applications, and workloads, data, and the qualities of data. FIG. 1 illustrates a scheduling engine 108 that is configured to perform an attribute-based analysis to identify a computing environment (e.g., infrastructure) for performing a workload and then placing that workload with the identified computing environment. The scheduling engine 108 is also configured to manage the environment and the placement/migration of workloads being performed in the computing environment.

The following discussion often refers to infrastructure as a node. A distributed computing environment may include multiple nodes (e.g., edge nodes). Each node may be a server computer, a cluster of servers, or other hardware. Each node may be embodied as one or more containers, virtual machines, physical machines, or the like.

The scheduling engine 108 orchestrates workloads using infrastructure attributes 102 (e.g., attributes of nodes including the node 110), workload attributes 104 (e.g., attributes of the workload 114 being placed), and/or data attributes 106 (e.g., attributes of the data 112). The attributes 102, 104, and 106 are matched or coordinated by the scheduling engine 108. In this example, after processing the attributes 102, 104, and 106, the scheduling engine 108 may select the node 110 to perform the workload 114.

Generally, the workload attributes 104 describe the requirements of the workload 114, the infrastructure attributes 102 describe the capabilities or resources, both active and passive, of the nodes available to the scheduling engine 108, and the data attributes describe qualities or characteristics of the data used, consumed, or generated by the workload 114. The scheduling engine 108 may analyze the attributes 102, 104, and 106 to generate a best fit for the workload 114.

For example, node attributes of the node 110 (and of other nodes available to the scheduling engine 108) may include information such as CPU cores, installed RAM (Random Access Memory), available RAM, storage installed, available storage, or the like. The workload attributes 104 of the workload 114 may include storage requirements, core requirements, latency requirements, or the like. When orchestrating the workload 114, the workload attributes 104 can be compared and matched to the infrastructure attributes 102. This may determine that the node 110 is best suited to perform the workload 114.

The data attributes 106 may also impact the selection of a specific node. For example, selecting a node closer to the data may reduce latency. As a result, the processing performed by the scheduling engine 108 may include for attributes such as processors, memory, storage, network latency and other attributes of the infrastructure, the workload and/or the data.

Once the attributes 102, 104, and 106 are matched and the node 110 is selected, the workload 114 may be deployed to the node 110. Performing the workload 114 may include, by way of example only, accessing/using/transforming/analyzing/changing/consuming, the data 112.

Generally, the infrastructure attributes 102 may include attributes that describe the capability and available capacity of infrastructure so support edge workloads (e.g., edge compute, storage, and network connectivity). Other infrastructure attributes 102 may include network-related statistics such as basic routing information, such as proximity to other nodes, bandwidth availability, communication speed capabilities, or the like.

The workload attributes 104 may include attributes that describe the requirements of workloads, such as workloads performed at the edge, with an intent to be best matched to the capabilities and location of edge infrastructure.

The data attributes 106 may include attributes that describe data streams and events available at edge locations and required by edge workloads.

For nodes, such as the node 110, the infrastructure or node attributes can be separated into static attributes and dynamic attributes. Static attributes include attributes that are mostly constant over time. Static attributes may include CPU core count, RAM installed, accelerators installed, or the like. In the event that these attributes change, the node may publish the information to the scheduling engine 108.

The dynamic attributes are those whose values change over time (rapidly in some instances). Examples include available RAM (distinct from installed RAM), remaining storage space, CPU load, and the like. These attributes may be a factor that contributes to workload placement and/or workload migration. As a result, these attributes may be monitored regularly to ensure that workloads are optimally placed in a computing environment. Stated differently, the node 110 may update its attributes with scheduling engine 108.

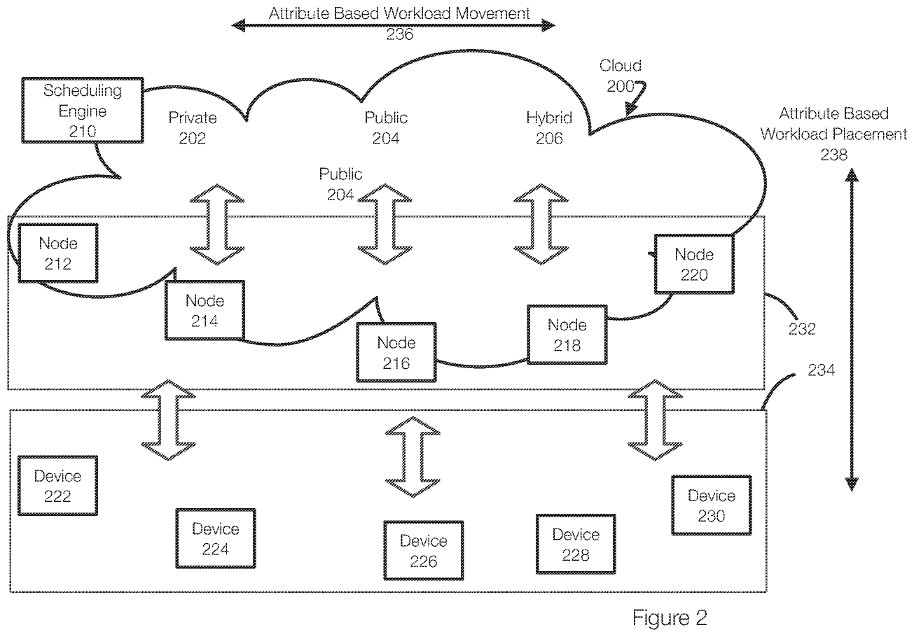

FIG. 2 discloses aspects of attribute-based workload movement and attribute-based workload placement. The cloud 200 is representative of one or more clouds. The cloud 200 may represent clouds or datacenters associated with the same prover or different provider. The cloud 200 may include private clouds 202, public clouds 204, and hybrid clouds 206.

In this example, a scheduling engine 210, an example of the scheduling engine 108, may be configured to orchestrate the placement and/or movement of workloads among infrastructure including edge infrastructure, represented by nodes 212, 214, 216, 218, and 220. The scheduling engine 210 may be implemented on a node such as the node 212. Each of the nodes 232 may each represent a computing environment such as an edge server, an edge station, a cluster of servers, or other infrastructure. The nodes 232 may be geographically diverse and may have different structures, latencies, and/or capabilities.

The devices 234, represented by devices 222, 224, 226, 228, and 230 are representative of devices that may interact with the nodes 232. The devices 234 may include smartphones, tablets, computers, servers, networks (e.g., a business local area network), and other IoT (Internet of Things) devices such as camera and other sensors.

The devices 234 may generate data that may be associated with a workload. The scheduling engine 210 may use attributes to orchestrate a workload. For example, the device 224 may be a weather-related system that includes various weather-related sensors. The data generated by these sensors may be processed by an application. Based on the attributes of the weather application or workload, the attributes of the data in the data stream, and the attributes of the nodes 232, the scheduling engine 210 may orchestrate the workload to the node 214 based on the attribute analysis.

In another example, the device 226 may constitute a backup appliance that sends data to be backed up to the cloud 200. The scheduling engine 210 can also orchestrate the workload (e.g., the backup operation) from the device 226 such that the workload is performed by the node 218. If necessary and based on the attributes of the workload, the node, or the data, which may change over time, workloads can be migrated to other nodes by the scheduling engine 210. Although FIG. 2 illustrates data being sourced from the devices 234, data may be sourced from other locations including the cloud 200.

FIG. 2 further illustrates both attribute-based workload movement 236 (e.g., migration) and attribute-based workload placement 238. The scheduling engine 210 is configured to evaluate the attributes of the nodes 232 as well as the attributes of the workload and/or attributes of the data to place a workload at one of the nodes 232. By way of example only, workload placement can be viewed as vertical when the workload is initially placed.

Workload migration generally refers to the movement of a workload from one node to another node. This may be performed when the scheduling engine 210 determines that the workload may be better serviced at a different node. Workload movement can be viewed as horizontal as the workload may be moved from one node to a different node.

Embodiments of the invention may account for a wide variety of different attributes, many of which are disclosed herein. The scheduling engine 210 can use one or more of these attributes to make orchestration decisions, including the initial placement and/or migration of a workload. Thus, the scheduling engine 210 uses the node attributes, workload attributes, and/or data attributes to drive workload placement/migration across distributed infrastructure based on, by way of example, attributes including or related to cost, performance, security, regulation, and/or other constraints, requirements, or service level agreements.

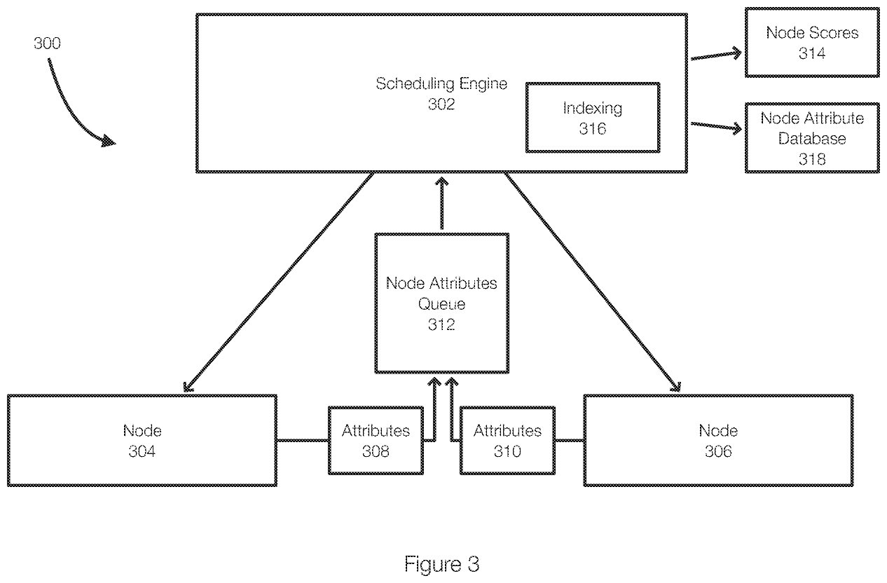

FIG. 3 discloses aspects of node attributes and of collecting node attributes. FIG. 3 illustrates a scheduling engine 302, which an example of scheduling engine 108, and nodes 304 and 406, which are representative of infrastructure (e.g., edge infrastructure) that is available for performing or executing workloads.

In the system 300, node data or statistics may be collected at the scheduling engine 302. For example, the scheduling engine 302 may send a query to the nodes 304 and 306 using an API (Application Programming Interface) to begin the process. An agent or client on the nodes 304 and 306 may leverage operating system primitives to gather information on the node or host operating system, physical and virtual memory statistics, and other runtime characteristics of the nodes 304 and 306. For example, Linux commands such as “proc/meminfo” and “Iscpu”, among others, can be used to obtain details such as CPUs, architecture, clock rate, byte order, total and available memory, system load, and network data.

In one example, the information collected at the nodes 304 and 306 are included in the attributes 308 for the node 304 and as the attributes 310 for the node 306. The attributes 308 and 310 are an example of a manifest or policy and may be formatted as an XML document. The attributes 308 and 310 are published to a node attributes queue 312 that is listened to by the scheduling engine 302.

When the attributes 308 are published to the node attributes queue 312, the scheduling engine 302 performs indexing 316 to index the attributes 308. The attributes may also be stored in a database 318. For example, the scheduling engine 302 may index the CPU architecture, Endianness, and available memory. The attributes that are indexed may be determined by an administrator or set by default, or the like.

Further, the scheduling engine 302 generates a node score for each of the nodes 304 and 306 that are stored as the node scores 314. The node scores 314 account for the capabilities of the nodes 304 and 306 at least in terms of CPU count, speed, available memory, and available storage. By way of example, the node scores 314 may change over time as workloads are added to the nodes 304 and 306, as workloads consume portions of the resources of the nodes 304 and 306, or as workloads complete. More specifically, the node scores of each of the nodes may go up or down over time. The node scores 314 may be updated, by way of example, when a workload is deployed, when a workload completes, when attributes are updated, or the like. This ensures that the scheduling engine 302 is operating with current or near current node attributes.

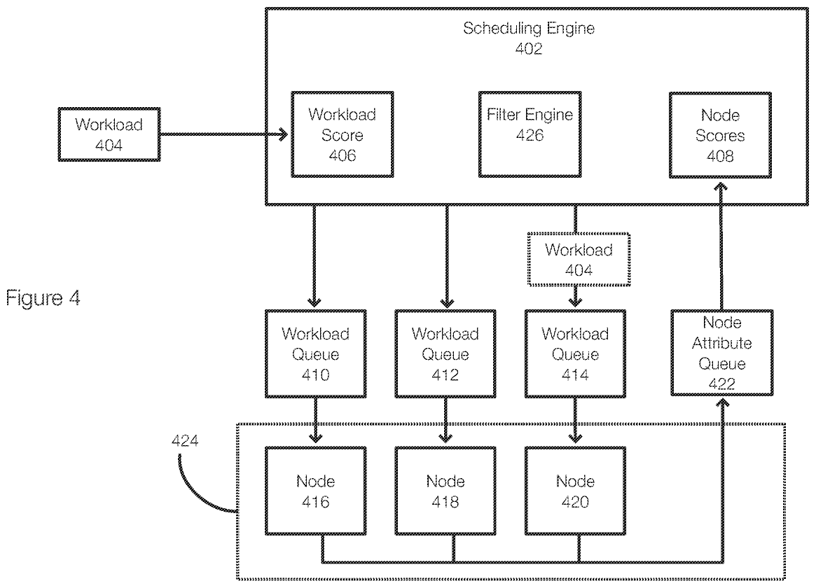

FIG. 4 discloses aspects of scheduling or orchestrating workloads in a distributed system. The system 400 includes a scheduling engine 402, which is an example of the scheduling engine 108, and a pool 424 of nodes, which is represented by the nodes 416, 418, and 420. The scheduling engine 402 is configured to place the workload 404 with one of the nodes in the pool 424. The nodes in the pool 424 may be geographically diverse and may have no relationships to each other except for belonging to the pool 424. The nodes in the pool 424 may have different owners or different providers.

Each of the nodes in the pool 424 is associated with a workload queue. More specifically, the nodes 416, 418, and 420 are associated with, respectively, the workload queues 410, 412, and 414. Workloads are received through the queues 410, 412, and 414. As previously stated, attributes of the nodes 416, 418, and 420 may be updated, for example, using the node attribute queue 422.

The scheduling engine 402 may receive a workload 404 or a request to place or orchestrate the workload 404. When the workload 404 arrives, the scheduling engine 402 may generate a workload score 406 for the workload 404. The workload score 406 may account, by way of example only, for the attributes of the workload 404. For example, the workload 404 may have attributes (or requirements) in terms of CPU count, speed, memory, and storage.

When placing the workload 404, the scheduling engine 402 may use a filter engine 426 filter the pool 424 of available nodes based on the workload attributes. The filter engine 426 may filter the nodes in stages. A first filtering may be based on hard (or static) attributes of the nodes in the pool 424. This may include comparing attributes of the workload 404 with hard or static node attributes to identify the nodes that satisfy the attributes (or requirements) of the workload 404.

After the initial filtering, which generates first candidate nodes, a second filtering or second stage is performed. In the second filtering, the first candidate nodes are filtered by the filter engine 426 using soft or dynamic attributes, such as available memory rather than memory installed, to generate second candidate nodes. Filtering may include comparing the workload attributes to the node attributes. Node attributes that do not satisfy the workload attributes may be filtered out or eliminated from consideration. For example, if a workload attribute is that 8 cores are required and a node only has 6 cores, that node is excluded in the first filtering stage. The second filtering stage may require a node to have 8 GB of available RAM for example.

In this example, the hard filtering and the soft filtering results in two candidate nodes: node 418 and 420. Thus, both the node 418 and the node 420 are suitable choices for performing the workload 404.

As previously stated, however, each node is associated with a node score, which can change over time, and which may be updated at the time of placing the workload 404. In this example, the scheduling engine 402 assigns the workload 404 to the node with the current highest node score, which is the node 420 in this example and as illustrated in FIG. 4. The node score may be determined in a variety of ways. In one example, each attribute of the workload that is satisfied by the node attributes may receive a point. If a node attribute exceeds a workload attribute by a certain percentage, this may receive an additional point or, in the alternative, may cause a point to be lost. A point may be lost in order to ensure, for example, that small workloads are not deployed to over-qualified nodes due, for example, to the potential cost involved. In other words, different attributes may impact the score differently in order to select a node that meets the attributes of the workload.

The workload 404 is assigned by placing the workload 404 (or an identifier or request) into the workload queue 414. The node 420 may listen to the workload queue 414 and, when the workload 404 is entered into the queue 414, the node 420 performs or executes the workload 404. In one example, multiple workloads may be placed in any of the queues and performed accordingly and in turn.

The node scores 408 are calculated such that a higher score indicates greater availability for the node to process a matching workload. If none of the nodes in the pool 424 at least match the workload score 406, a best fit process is used. In this example, the workload is assigned to the node with the highest score. In other examples, the manner in which the score is determined may vary. The scoring scheme may be configured such that the best current score is the highest score, or the lowest score, or the like.

In a non-optimal situation, such as when no node has a sufficient node score, the workload 404 may be marked as movable. However, any workload can be marked as movable or non-movable. This allows the scheduling engine 402 to self-optimize. For example, if it is assumed that none of the nodes 416, 418, and 420 had a node score that matched or was greater than the workload score 406, the workload 404 is assigned to the node 420 and placed in the queue 414 because the node 420 has the highest score.

Later, the node score of the node 416 increases and matches or is greater than the workload score 406. For example, a workload executing at the node 416 may terminate and free some of the resources of the node 416.

When migrating workloads, the scheduling engine 402 accounts for the fact that multiple workloads may benefit from migration. In one example, the scheduling engine 402 may search for or identify a movable workload with the highest score and for a node score that is higher than the moveable workload's score. When such a node is available, the workload is migrated to that node. In this example, the workload 404 may be migrated to the node 416 when the node score of the node 416 changes and is higher that the workload score.

FIG. 5 discloses aspects of collecting node attributes. The method 500 relates generally to node attributes and to the collection of node attributes. A client or other agent may be installed on each node. The client is configured to collect node 502 attributes. The attributes are then published 504 to a node attribute queue associated with the scheduling engine.

Next, the node (or client operating thereon) may establish 506 a workload queue for the node. This workload queue is specific to the node. Workloads are orchestrated or placed with the node via the workload queue. The client may update 508 node attributes. For example, the node attributes may be updated based on a frequency, when a new workload is added/started, when a workload is completed, when the attributes change, or the like. Updating 508 the node attributes is useful at least because some of the attributes change quickly. For example, a hard attribute of installed RAM may not change frequently. However, the available RAM, available storage, core usage, and the like are attributes whose values may fluctuate frequently and quickly. Updating the node attributes ensures that workloads are placed or orchestrated more effectively by the scheduling engine using current or recent node attribute values.

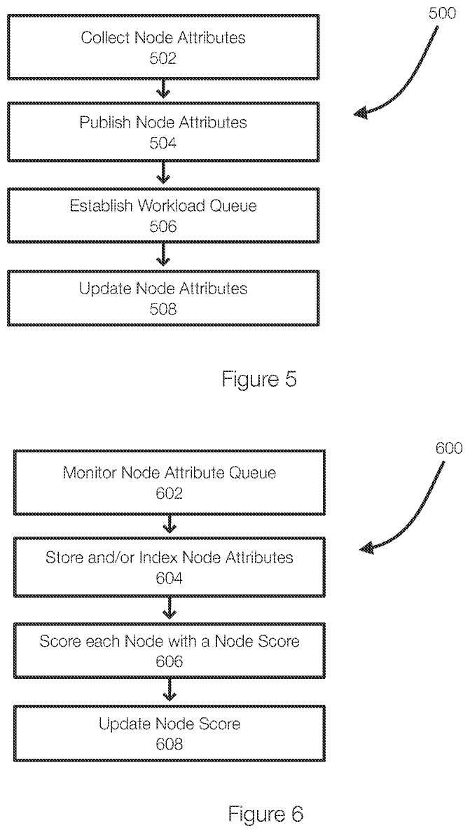

FIG. 6 discloses aspects of attribute-based workload orchestration. In the method 600, the scheduling engine may monitor 602 or listen to the node attribute queue. When node attributes are published into the node attribute queue by the nodes, the scheduling engine stores 604 the attributes. The scheduling engine may also index 604 at least some of the node attributes. Indexing allows a node to be assigned a workload when relying on a specific attribute or on a few specific attributes. For example, if the attribute of interest is processor cores, accessing the index based on processor cores can quickly identify candidate nodes for a corresponding workload. Other attributes that may be indexed include CPU architecture, Endianness, and available memory. Less than all of the attributes may be indexed.

Next, a node is scored 606 with a node score. The node score, as previously stated, may account for its core capabilities in terms of CPU count, speed, available memory, and available storage. The node score may be updated 608 as the attributes of the node change. For example, the node score may decrease when a workload starts or may increase when a workload completes.

The node score may be generated by comparing the node's attributes to a set of predetermined threshold values. The deviation from the threshold values may translate into a score. In one example, the node score may be updated in real-time (e.g., when placing a workload) to account for the manner in which the attributes are compared with other attributes. A higher score is given when more attributes match or are satisfied.

In one example, a standard set of attributes may be used to describe infrastructure and capacity. These attributes may include CPU (e.g., cores), accelerators, total storage, available storage, total bandwidth, available bandwidth, total RAM, available RAM. The attributes used to describe workloads may also be standardized to include latency, CPU, memory, data and telemetry, storage volumes, connectivity, accelerators installed, or the like. However, the set of attributes identified as standard may vary or can include other groupings of attributes.

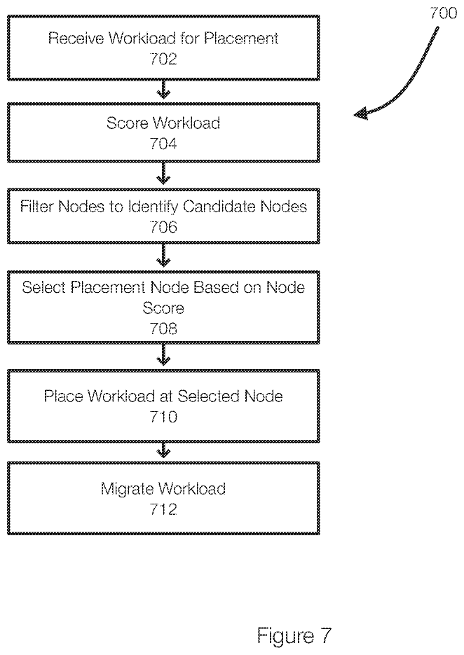

FIG. 7 discloses aspects of placing and/or migrating a workload. In the method 700, a workload is received 702 for placement. The workload attributes are evaluated, and the workload is scored 704 a workload score.

Next, the available nodes are filtered 706 to identify candidate nodes for placement of the workload. The nodes may be filtered in stages as previously described. Once the candidate nodes are identified, the placement node (the node to which the workload is directed or placed) is identified based on the node score. Generally, the node in the candidate nodes with the highest node score is selected 708.

More specifically, filtering 706 the nodes may include comparing the workload attributes with the node attributes and/or the data attributes. This ensures that the candidate nodes meet the attributes (e.g., requirements) of the workload. This also ensures that the data attributes are accounted for when identifying the candidate nodes. For example, a workload attribute may specify a latency. The geography attribute of the data may exclude certain nodes from being candidates or may ensure that other nodes are candidates for the workload.

The workload is then placed 710 at the selected node. This may include placing an entry in the selected node's workload queue. If necessary, the workload may be migrated to another node. Migrating a workload is not necessarily required but may be performed to optimize the orchestration of workloads.

Prior to migrating a workload, a pause message/notification is sent to the node. The node may examine the state and the attributes of the workload to determine if the node can migrate the workload. If the workload can be migrated, an acknowledgement is sent to the scheduling engine at the appropriate time. If the workload cannot be migrated, due for example to work in progress, interactivity with resources or other systems, or user interaction, a non-acknowledgement message is returned, indicating that the workload will not be migrated.

Using infrastructure capability, workload requirements, and data quality characteristics (expressed as attributes herein) in concert, a scoring mechanism can be used to drive workload placement and workload migration across vastly different distributed infrastructure. Embodiments of the invention allow a declarative model of deployment and runtime characteristics of complex distributed systems. Further, these attributes can be used as define how and when a workload is scheduled and/or migrated. Further, this can be automated and automatic. Plus, workloads can be migrated repeatedly as better options become available, creating an autonomous, self-optimizing orchestration system.

The scheduling engine may maintain metadata that allows the scheduling engine to understand where workloads are running, which workloads are in queues, which workloads are moveable, or the like. The scheduling engine may also maintain time information that gives an insight into when workloads may finish, how long a migration takes, and the like. In one example, workloads are containerized or performed in other schemas.

The following discussion describes example workload attributes, node attributes, and data attributes. Some of the attributes may be common attributes and are included in each of the node, workload, and data attributes. Some of the attributes are identified as require while others are identified as optional. However, these attributes and their definitions and descriptions are presented by way of example only. Attributes listed as required may, in the alternative, be optional. Attributes listed as optional may, in the alternative, be required. In addition, embodiments of the invention may use or rely on less than all of the attributes identified herein. Attributes not available or not applicable may be ignored in one example and may not impact the overall score. In another example, the absence of specific attributes may adversely impact the overall score. Further, node scores and workload scores may be based on any one or more of the following attributes.

### Common Attributes—Used by Edge Nodes, Workload, and Data Attribute Definitions)

These are attributes that are reused within the attribute structures to define parts of node capabilities, workload requirements, and telemetry data.

### Attribute: Description

This attribute grouping contains individual attributes to describe a component in terms of its type (i.e., a PowerFlex storage node), formal name, model, and so on. This is used to describe infrastructure components such as nodes, FPUs, storage devices, and so on.

Used by attributes:
Node
Node/GPU
Node/Accelerator
Node/NetworkAdapter
Node/InputOutput
Node/Storage

| Attribute Name | Description | Type |
|---|---|---|
| Type | A meaningful type description of the component | Required |
| Name | A human readable name for description purposes | Optional |
| Model | The formal component model | Optional |
| Year | The year of manufacture | Optional |
| Manufacturer | The provider of the component | Optional |
| HardwareID | A meaningful machine-readable ID for the component | Optional |

### Attribute: Cores

For components that contain or require processing cores of various types.

Used by attributes:
Node/CPU
Node/GPU
Workload/Compute/MaxCPU
Workload/Compute/MinCPU

| Attribute Name | Description | Type |
|---|---|---|
| Type | Types of cores include Compute, CUDA, Tensor, Neural | Required |
| Count | The number of cores within a physical unit (i.e., CPU die) | Required |

### Attribute: Runtime

A runtime is a support platform for an application. This can include an environmental component such as those to run virtual machines and containers, along with application language runtimes such as Python and the Java VM.

Used by attributes:
Node/Container
Node/Platform
Workload

| Attribute Name | Description | Type |
|---|---|---|
| Name | The container or platform runtime: | Required |
| | Kubernetes | |
| | Docker | |
| | containderd | |
| | Envoy | |
| | Istio | |
| | CoreOS | |
| | Mesos | |
| | Swarm | |
| | JVM | |
| | Python | |
| Version | The version of the runtime, i.e., version “19.03.8” | Required |
| Manufacturer | The vendor/manufacturer of the runtime, i.e., Oracle JVM | Optional |

### Attribute: Sample

A data sample is described as something that has a periodic rate of delivery, as well as an expected size in terms of bytes per data sample.

Used by attributes:
Workload/Stream
Data/Stream

| Attribute Name | Description | Type |
|---|---|---|
| Rate | The periodic rate of delivery of the data, in samples | Required |
| | per second | |
| Size | The size, in bytes, of each same of data. Should be max | Required |
| | size if there exists variability from sample to sample | |

### Attribute: Subscription

This attribute contains attributes that describe a data subscription, such as to periodic data (data stream) or non-periodic data (events).

Used by attributes:
Workload/Stream
Workload/Event

| Attribute Name | Description | Type |
|---|---|---|
| Subject | The unique subscription name by which an edge application can | Required |
| | register interest to receive data from a particular data stream | |
| Credentials | An encrypted set of credentials required for the subscription | Required |

### Edge Node Attributes

This section defines the attributes used to describe edge infrastructure capabilities and capacity. For example, attributes include characteristics that define the CPU processing power in terms of core count and clock rate, total memory and available capacity, network latency, storage capacity, and so on.

### Hierarchy Overview

The list of all attributes used to describe edge nodes is discussed below. Note that some entries may be repeating, meaning there can be one or more of them (i.e., multiple Storage Platform entries) and some may be absent (i.e., no Container entries).

| Section Name | Description | Required |
|---|---|---|
| Description | This section describes the edge node hardware | Yes |
| | in terms of type of node, manufacturer, age, | |
| | and so on. The full set of attributes are | |
| | defined in the “Description section above. | |
| CPU | Defines the capabilities and capacity of node's | Yes |
| | CPU processing power. | |
| Memory | Attributes that describe the total and dynamic | Yes |
| | capacity, and speed of RAM and virtual memory. | |
| GPU | Attributes that describe the type of GPU | No |
| | installed within the node, its capabilities, | |
| | and available capacity | |
| Accelerators | Defines attributes for any accelerators (other | No |
| | than GPU) installed within the node, such as | |
| | a SmartNIC. | |
| NetworkAdapter | Zero or more groups of attributes that describe | Yes |
| | the different network adapters and their capacity | |
| | available within the node, such as Ethernet, | |
| | Bluetooth, Fibrechannel, and so on. | |
| Storage | Zero or more groups of attributes that describe | No |
| | storage systems and capacity available to | |
| | workloads running on the node. | |
| InputOutput | Zero or more groups of attributes that describe | No |
| | other IO devices, such as video display adapters | |
| | (output), video cameras (input), or other data | |
| | gathering or HMI components. | |
| OS | Attributes that describe the host OS running on | Yes |
| | the node (i.e., Windows, VMWare ESX, Linux . . .) | |
| Container | Zero or more groups of attributes, as defined | No |
| | in the “Runtime” section above, that | |
| | describe container runtimes available on the | |
| | node to support workload containers. | |
| Platform | Zero or more groups of attributes, as defined | No |
| | in the “Runtime” section above, for | |
| | each application platform supported. | |
| Cost | Attributes that describe the general cost of | Yes |
| | running workloads on the infrastructure in | |
| | terms of the time units and currency provided. | |
| Energy | Attributes classified as related to energy | No |
| | efficiency if it captures relevant current | |
| | and/or historical data. | |
| Security | Attributes related to the security of the | Yes |
| | infrastructure. | |

### Attribute: CPU

These attributes describe the CPU(s) that are installed, their architecture, core counts, and other characteristics that may prove critical to know prior to deploying workloads to an edge node. All are static attributes except for CurrentLoad and AverageLoad, which are dynamic.

| Attribute Name | Description | Type |
|---|---|---|
| Architecture | The instruction set architecture of the CPU. | Required |
| | The choices are: | |
| | X86 | |
| | X64 | |
| | ARM | |
| | ARM64 | |
| | Blackfin | |
| | PA-RISC | |
| | RISC-V | |
| | PowerPC | |
| | 6502 | |
| Count | The number of physic CPUs (not cores) installed | Required |
| | within the node | |
| Cores | Consists of attributes defined in the “Cores' section | Required |
| | above. In general, the number of cores per CPU | |
| | installed in the node. There can be one or more | |
| | entries, one for each type of core (i.e., general | |
| | purpose, neural, and so on) supported within the CPU | |
| ClockRate | The clock rate (i.e., 1.86 GHtz) for each CPU | Required |
| Endianess | Little or Big endian. While some workloads (i.e., | Required |
| | Python or Java) may not depend on the value of | |
| | Endianess, others such as natively compiled | |
| | C-based workloads do. | |
| Bitness | 32 or 64 bits. Some workloads require resource | Required |
| | sizing (i.e., memory) that dictates the need | |
| | for 64 bits over 32. | |
| CurrentLoad | Current percentage of total CPU load (usage) on | Required |
| | the node | |
| AverageLoad | Average percentage of total CPU load since boot up | Required |
| Model | Text that describes the model of CPU(s) installed | Optional |

### Attribute: Memory

Edge node RAM is described by a set of attributes that indicate memory type, speed, total amount installed in the node, amount available at the time, along with total and available virtual memory. The AvailableRAM and AvailableVirtual attributes are dynamic.

| Attribute Name | Description | Type |
|---|---|---|
| Type | Type of memory installed, such as: | Required |
| | DDR | |
| | DDR2 | |
| | LPDDR2 | |
| | DDR3 | |
| | LPDDR3 | |
| | DDR4 | |
| | LPDDR4 | |
| | DDR5 | |
| | LPDDR5 | |
| | DDR6 | |
| | LPDDR6 | |
| | . . . | |
| Speed | 2666 | Required |
| TotalRAM | Total RAM installed within the node | Required |
| AvailableRAM | Available free RAM at the moment of query | Required |
| TotalVirtual | Total virtual memory available to the node | Required |
| AvailableVirtual | available free virtual memory at the time of query | Required |

### Attribute: GPU

Although a GPU is type of accelerator (which, in general, have their own section of attributes within a set of Edge node attributes) GPU attributes are considered called out within their own section. All are static attributes except for AvailableRAM, which is dynamic as it can change rapidly over time.

| Attribute Name | Description | Type |
|---|---|---|
| Description | Consists of attributes defined in the “Description | Required |
| | section above | |
| TotalRAM | Total RAM included with the GPU | Required |
| AvailableRAM | The amount of free RAM (not consumed) available | Required |
| | to the GPU at the time of query | |
| Bitness | 32 or 64 bits | Required |
| Cores | Consists of attributes defined in the “Cores' section | Required |
| | above. Repeating block based on types of cores | |
| | supported. | |
| RequestsLimit | Amount of parallelism for multi-tenancy support | Required |

### Attribute: Accelerator

This section is used to describe other accelerators installed within the edge node, such as a SmartNlC. Information about the accelerator is included in the attribute list, as part of common Definition set of attributes.

| Attribute Name | Description | Type |
|---|---|---|
| Description | Consists of attributes defined in the “Description | Required |
| | section above | |

### Attribute: NetworkAdapter

To best describe the connectivity options available at the Edge node, a set of repeating entries, one for each network adapter installed, are defined. These include Ethernet, Wifi, Bluetooth, Fibrechannel, and other potential network adapter types. The attribute AvailableBandwidth is the only dynamic attribute in this set.

| Attribute Name | Description | Type |
|---|---|---|
| Description | Consists of attributes defined in the “Description | Required |
| | section above | |
| MaxBandwidth | The total bandwidth available for this memory | Required |
| | subsystem, i.e., 1000 Mbps | |
| AvailableBandwidth | The amount of bandwidth available (not consumed) | Required |
| | at the time of query | |
| MaxLatency | Maximum amount of latency for data transmission | Required |

### Attribute: Storage

Each Edge node may have direct attached storage, or network attached storage that is available to edge applications. These attributes describe the type of storage available and its characteristics. AvailableBytes is the only dynamic attribute in the set.

| Attribute Name | Description | Type |
|---|---|---|
| Description | Consists of attributes defined in the “Description” | Required |
| | section above | |
| MediaType | The type of storage device (i.e., NVMe) | Required |
| TotalBytes | The total size capacity of the storage device | Required |
| AvailableBytes | The amount of available storage at the time of query | Required |
| Bandwidth | Maximum bytes per second that can be transferred to | Required |
| | and from the storage device | |
| Throughput | Depending on the storage type, can be expressed in | Required |
| | bytes-per-second, IO operations per second, or | |
| | transactions per second | |
| MaxLatency | Time between data request (read or write) and time | Required |
| | that the data is returned, or notification is received | |
| | that the data was safely stored, respectively. | |

### Attribute: InputOutput

The set of Edge node attribute can contain zero or more groups of attributes that describe other I/O devices, such as video display adapters (output), video cameras (input), or other data gathering or HMI components. All are static attributes.

| Attribute Name | Description | Type |
|---|---|---|
| Description | Consists of attributes defined in the | Required |
| | “Description” section above | |
| Resolution | For display devices, the resolution in | Optional |
| | pixels | |
| EncoderType | The type of encoding, if any, for data | Optional |
| | input or output | |
| EncoderMode | HDMI | Optional |
| Color | Supported color mode: NTSC or PAL | Optional |
| Bitrate | The bitrate for data transmission | Optional |
| Framerate | Frame refresh rate for video support | Optional |
| Quality | Image quality, potentially impacted by | Optional |
| | compression and/or bandwidth constraints | |

### Attribute: Container

The Edge node can have zero or more container runtimes installed, described in this section. Each runtime is described in repeating Runtime attribute blocks within this section to indicate each runtime available, and their versions.

| Attribute Name | Description | Type |
|---|---|---|
| Runtime | Zero or more groups of attributes, as | Optional |
| | described in the “Runtime” section above, | |
| | to describe the container runtimes installed | |
| | to support workloads on this node, i.e., | |
| | Docker, Kubernetes. | |

### Attribute: Platform

The Edge node can have zero or more application runtime platforms installed, described in this section. Each runtime platform is described in repeating Runtime attribute blocks within this section to indicate each one available, and their versions. Each of these attributes is static.

| Attribute Name | Description | Type |
|---|---|---|
| Runtime | Zero or more groups of attributes, as | Optional |
| | described in the “Runtime” section | |
| | above, to describe the application runtimes | |
| | installed to support workloads on this | |
| | node, i.e., JVM, Python. | |

### Attribute: OS

These attributes describe the host OS installed on the node. Guest OS instances are not included here in this example. Each of these attributes is static.

| Attribute Name | Description | Type |
|---|---|---|
| Name | Operating System official name, i.e., | Required |
| | “Microsoft Windows 10 Enterprise” | |
| Kernel | Choose between: | Required |
| | Linux | |
| | Windows | |
| | Solaris | |
| | VMWare ESX | |
| Version | The official OS version, i.e., “10.0.17134” | Required |
| Manufacturer | OS or distribution vendor, i.e., “Microsoft”, | Required |
| | “Ubuntu”, etc | |
| Bitness | 32- or 64-bit OS | Required |

### Attribute: Cost

The cost associated with running workloads on edge nodes is part of the automated deployment decision process. The attributes here work together to both quantify the costs in terms of base currency, time unit to be applied to the cost-based metrics, and the three cost-based metrics that might apply. Although all three are not required, to make cost-based deployment analysis work, at least one of these metrics should be defined.

| Attribute Name | Description | Type |
|---|---|---|
| Currency | The currency the cost is described | Required |
| | with, i.e., USD | |
| TimeUnit | The unit of time the PerCore, PerGBRAM, | Required |
| | and PerServiceCall values apply to | |
| PerCore | The price per core per time unit defined | Optional |
| | by the TimeUnit attribute | |
| PerGBRAM | The price GB of RAM per time unit defined | Optional |
| | by the TimeUnit attribute | |
| PerServiceCall | The price per service call per time unit | Optional |
| | defined by the TimeUnit attribute | |

### Attribute: Energy

The energy consumption of nodes associated with running workloads on edge nodes is part of the automated deployment decision process. The attributes here work together to both quantify the energy usage over time, as well as an industry standard energy rating. In some examples, the energy attribute can be impacted by usage and/or the type of workloads placed. In some instances, it may be beneficial to compare the attributes to other similarly utilized nodes (e.g., accounting for node or server load over a similar period, such as 7 days).

| Attribute Name | Description | Type |
|---|---|---|
| Rating | An industry standard energy efficiency | Optional |
| | rating | |
| AvgUsage | Average energy usage over the last 7 | Optional |
| | days | |
| PeakUsage | The maximum power draw for the device | Optional |
| | under full utilization | |
| IdleUsage | The minimum power draw for the device | Optional |
| | when idle | |

### Attribute: Security

Examples include the existence of a trusted compute module, network security implementation, trust level, methods of attestation and non-repudiation, zero trust architecture compliance, and so on.

### Workload Requirement Attributes

This section defines the attributes that describe the requirements of workloads, including edge workloads, with the intent to be best matched to the capabilities and location of edge infrastructure or node to run on. These include attributes grouped to describe compute requirements, memory requirements, storage requirements, and so on.

### Hierarchy Overview

| Section Name | Description |
|---|---|
| Compute | Attributes defining workload needs in terms |
| | compute/CPU capacity and characteristics |
| Memory | Attributes that outline workload memory |
| | requirements |
| Storage | Zero or more entries defining required storage |
| | characteristics |
| Accelerator | Zero or more entries defining required hardware |
| | accelerators |
| Network | Zero or more entities defining minimum network |
| | bandwidth capabilities |
| Runtime | Zero or more entries defining required |
| | application runtime support, as defined in the |
| | “Runtime” section above, i.e., Docker, JVM, |
| | Python, and so on. |
| Stream | Consists of attributes from zero or more entries |
| | defined in the “Data Attributes” sections, below. |
| Event | Consists of attributes from zero or more entries |
| | defined in the “Data Attributes” sections, below. |
| Energy | Energy efficiency SLA |
| Security | Security related SLA |

### Attribute: Compute

This grouping of attributes defines the processing power and type required to execute the workload.

| Attribute Name | Description | Type |
|---|---|---|
| Architecture | The required architecture of the workload | Required |
| | and its platform runtime requirements | |
| MinCPU | Consists of attributes defined in “Cores” | Required |
| | section above | |
| MaxCPU | Consists of attributes defined in “Cores” | Required |
| | section above | |
| MinClockrate | The minimum CPU clockrate required | Required |
| | to execute this workload | |
| Bitness | 32- or 64-bit environment | Required |
| Endianess | Big or Little | Optional |

### Attribute: Memory

This group of attributes define the minimum and ideal memory requirements to execute the workload.

| Attribute | | |
|---|---|---|
| Name | Description | Type |
| MinRAM | The minimum amount of RAM required | Required |
| | to execute this workload | |
| MaxRAM | The maximum amount of RAM this workload | Optional |
| | will consume. Not specifying it implies | |
| | no limit or requirement. | |
| MinSpeed | The minimum clockrate of the memory | Optional |
| | as required by the workload. Absence of | |
| | this attribute implies no requirement | |

### Attribute: Storage

This group of attributes describe the storage requirements for the workload. There may be zero or more repeating groups of Storage attributes for a workload.

| Attribute | | |
|---|---|---|
| Name | Description | Type |
| Type | The type of storage required by the | Required |
| | workload: | |
| | Block | |
| | File | |
| | Object | |
| | RDBMS | |
| | NoSQL | |
| MaxLatency | The maximum latency of the storage | Required |
| | to support this workload, i.e., the | |
| | read/write latency of the edge | |
| | storage must be equal to or less | |
| | than this value. | |
| MinSizeBytes | The minimum amount of storage | Required |
| | required for this workload | |
| MaxSizeBytes | The maximum amount of storage | Required |
| | the workload will require | |
| MaxThroughput | The maximum amount of throughput | Required |
| | (bytes/second) this workload will | |
| | consume | |
| MaxIOPS | The maximum amount of IO operations | Optional |
| | per second this workload will consume | |
| MaxTPS | The maximum amount of transaction | Optional |
| | per second this workload will consume | |

### Attribute: Accelerator

This group of attributes define hardware accelerators required to execute or support the workload. There can may be zero or more repeating groups of Accelerator attributes for a workload

| Attribute Name | Description | Type |
|---|---|---|
| Type | The type of accelerator required by | Required |
| | this workload, i.e., SmartNIX | |
| Name | The name of the accelerator, i.e., | Optional |
| | Mellanox | |
| Model | The model's name or number | Optional |
| RequestsPerSecond | The capacity the workload will demand | Required |
| | of the accelerator | |

### Data Attributes

This section defines attributes that describe data streams and events available at edge locations and required by edge workloads.

### Hierarchy Overview

| Section Name | Description |
|---|---|
| Stream | Data that arrives according to a predictable |
| | and well-defined periodic data rate |
| Event | Aperiodic data, arriving whenever conditions |
| | arise that trigger the event in question |

### Attribute: Stream

A data stream is classified as data that arrives according to a predictable and well-defined periodic data rate, or sample.

| Attribute | | |
|---|---|---|
| Name | Description | Type |
| Direction | This attribute describes the direction of | Required |
| | data flow. The choices are: | |
| | Inbound: from the device or device edge, | |
| | to the edge or cloud application | |
| | Outbound: from the edge or cloud application, | |
| | to the device or device edge | |
| Name | The name of the data stream, i.e., Temperature | Required |
| Sample | The data sample rate and size, as described | Required |
| | in the “Sample” section earlier in | |
| | the document. | |
| MaxLatency | This attribute describes the maximum amount | Required |
| | of latency tolerated from when the data is | |
| | gathered and transmitted, to when it must | |
| | be processed. This is used to help edge | |
| | workload placement, as the lower the latency, | |
| | the closer the workload will need to be to | |
| | the point of data acquisition. | |
| Encoding | Describes the potential encoding of the data | Optional |
| Type | Describes the delivery type of the data | Required |
| Subscription | Describes how an application should subscribe | Optional |
| | to the data, as defined in the “Subscription” | |
| | section earlier in this document. | |

### Attribute: Event

An event is classified separately from a stream in that it, unlike a stream, isn't periodic. Events don't arrive at a predictable rate, but are instead aperiodic, arriving whenever conditions arise that trigger the event in question (i.e., temperature passing a threshold, a user hitting a button, and so on).

| Attribute | | |
|---|---|---|
| Name | Description | Type |
| Direction | This attribute describes the direction of | Required |
| | data flow. The choices are: | |
| | Inbound: from the device or device edge, | |
| | to the edge or cloud application | |
| | Outbound: from the edge or cloud | |
| | application, to the device or device edge | |
| Name | The name of the data stream, i.e., | Required |
| | Temperature | |
| MaxLatency | This attribute describes the maximum amount | Required |
| | of latency tolerated from when the data is | |
| | gathered and transmitted, to when it must | |
| | be processed. This is used to help edge | |
| | workload placement, as the lower the latency, | |
| | the closer the workload will need to be to | |
| | the point of data acquisition. | |
| Encoding | Describes the potential encoding of the data | Optional |
| Type | Describes the delivery type of the data | Required |
| Subscription | Describes how an application should subscribe | Optional |
| | to the data, as defined in the “Subscription” | |
| | section earlier in this document. | |

### Attribute: Energy

The energy consumption constraints of workloads to help guide the automated deployment decision process. The attributes here work together to both quantify the energy usage over time, as well as an industry standard energy rating.

| Attribute | | |
|---|---|---|
| Name | Description | Type |
| MinRating | An industry standard energy efficiency | Optional |
| | rating | |
| MaxUsage | The device that executes this workload | Optional |
| | should not exceed this wattage of energy | |
| | usage | |

### Attribute: Security

This section relates to security requirements edge infrastructure must meet in terms of SLAs in order to execute the workload. Examples include the existing of a trusted compute module, secure network, trust level, methods of attestation and non-repudation, and so on.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that workloads can be optimally and continually placed and/or migrated in a distributed system with varying infrastructure in an automated manner.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, orchestration operations, placement operations, scoring operations, migration operations, attribute operations, or the like or combination thereof.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices in the operating environment may take the form of software, physical machines, containers, or VMs, or any combination of these, though no particular device implementation or configuration is required for any embodiment.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method, comprising: receiving, by a scheduling engine, a workload for placement in a distributed computing environment, the distributed computing environment including nodes that are each associated with a node score, scoring the workload, by the scheduling engine, with a workload score that is based on attributes of the workload, selecting a placement node from among the nodes for placing the workload based on the workload score and the node scores, wherein the selected node has a current best node score, and placing the workload at the selected node.

Embodiment 2. The method of embodiment 1, further comprising generating the node scores based on the node attributes such that each node is associated with a node score wherein the current best node score is a lowest node score when using a first scoring mechanism and wherein the current best node score is a highest node score when using a second scoring mechanism.

Embodiment 3. The method of embodiment 1 and/or 2, further comprising generating the node scores based on the node attributes such that each node is associated with a node score.

Embodiment 4. The method of embodiment 1, 2, and/or 3, further comprising updating the node scores, wherein the node attributes include static node attributes and dynamic node attributes.

Embodiment 5. The method of embodiment 1, 2, 3, and/or 4, further comprising accounting for data attributes associated with data used by the workload and node attributes of the nodes, wherein the workload attributes, the node attributes, and the data attributes each include one or more of computer attributes, memory attributes, storage attributes, accelerator attributes, network attributes, runtime attributes, stream attributes, event attribute, energy attributes, and/or security attributes.

Embodiment 6. The method of embodiment 1, 2, 3, 4, and/or 5, further comprising filtering the nodes to identify candidate nodes, wherein the filtering includes comparing the workload attributes to the node attributes and/or data attributes.

Embodiment 7. The method of embodiment 1, 2, 3, 4, 5, and/or 6, wherein filtering the nodes includes a first filtering based on static node attributes and a second filtering based on dynamic node attributes.

Embodiment 8. The method of embodiment 1, 2, 3, 4, 5, 6, and/or 7, further comprising selecting the placement node from among the candidate nodes based on at least the node scores of the candidate nodes.

Embodiment 9. The method of embodiment 1, 2, 3, 4, 5, 6, 7, and/or 8, further comprising migrating the workload from the placement load to a second node included in the nodes.

Embodiment 10. The method of embodiment 1, 2, 3, 4, 5, 6, 7, 8, and/or 9, further comprising migrating the workload when the workload is moveable and the second node has a sufficient node score.

Embodiment 11. A method for performing any of the operations, methods, or processes, or any portion of any of these or any combination thereof, disclosed herein.

Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ or ‘engine’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

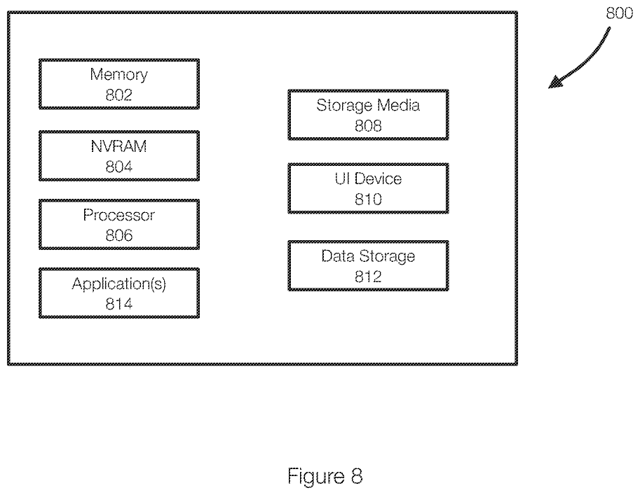

With reference briefly now to FIG. 8, any one or more of the entities disclosed, or implied, by the Figures and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 8.

In the example of FIG. 8, the physical computing device 800 includes a memory 802 which may include one, some, or all, of random access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory components 801 of the physical computing device 800 may take the form of device (SSD) storage. As well, one or more applications 814 may be provided that comprise instructions executable by one or more hardware processors 806 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, by a scheduling engine, a workload for placement in a distributed computing environment, the distributed computing environment including nodes that are each associated with a node score;
scoring the workload, by the scheduling engine, with a workload score that is based on attributes of the workload;
selecting a placement node from among the nodes for placing the workload based on the workload score and the node scores, wherein the selected node has a current best node score; and
placing the workload at the selected node.

2. The method of claim 1, further comprising receiving node attributes from each of the nodes at the scheduling engine.

3. The method of claim 2, further comprising generating the node scores based on the node attributes such that each node is associated with a node score, wherein the current best node score is a lowest node score when using a first scoring mechanism and wherein the current best node score is a highest node score when using a second scoring mechanism.

4. The method of claim 3, further comprising updating the node scores, wherein the node attributes include static node attributes and dynamic node attributes.

5. The method of claim 1, further comprising accounting for data attributes associated with data used by the workload and node attributes of the nodes, wherein the workload attributes, the node attributes, and the data attributes each include one or more of computer attributes, memory attributes, storage attributes, accelerator attributes, network attributes, runtime attributes, stream attributes, event attribute, energy attributes, and/or security attributes.

6. The method of claim 1, further comprising filtering the nodes to identify candidate nodes, wherein the filtering includes comparing the workload attributes to the node attributes and/or data attributes.

7. The method of claim 6, wherein filtering the nodes includes a first filtering based on static node attributes and a second filtering based on dynamic node attributes.

8. The method of claim 7, further comprising selecting the placement node from among the candidate nodes based on at least the node scores of the candidate nodes.

9. The method of claim 1, further comprising migrating the workload from the placement load to a second node included in the nodes.

10. The method of claim 9, further comprising migrating the workload when the workload is moveable and the second node has a sufficient node score.

11. A non-transitory storage medium having stored therein instructions that are executable by one or more hardware processors to perform operations comprising:
receiving, by a scheduling engine, a workload for placement in a distributed computing environment, the distributed computing environment including nodes that are each associated with a node score;
scoring the workload, by the scheduling engine, with a workload score that is based on attributes of the workload;
selecting a placement node from among the nodes for placing the workload based on the workload score and the node scores, wherein the selected node has a current best node score; and
placing the workload at the selected node.

12. The non-transitory storage medium of claim 11, further comprising receiving node attributes from each of the nodes at the scheduling engine.

13. The non-transitory storage medium of claim 12, further comprising generating the node scores based on the node attributes such that each node is associated with a node score, wherein the current best node score is a lowest node score when using a first scoring mechanism and wherein the current best node score is a highest node score when using a second scoring mechanism.

14. The non-transitory storage medium of claim 13, further comprising updating the node scores, wherein the node attributes include static node attributes and dynamic node attributes.

15. The non-transitory storage medium of claim 11, further comprising accounting for data attributes associated with data used by the workload and node attributes of the nodes, wherein the workload attributes, the node attributes, and the data attributes each include one or more of computer attributes, memory attributes, storage attributes, accelerator attributes, network attributes, runtime attributes, stream attributes, event attribute, energy attributes, and/or security attributes.

16. The non-transitory storage medium of claim 11, further comprising filtering the nodes to identify candidate nodes, wherein the filtering includes comparing the workload attributes to the node attributes and/or data attributes.

17. The non-transitory storage medium of claim 16, wherein filtering the nodes includes a first filtering based on static node attributes and a second filtering based on dynamic node attributes.

18. The non-transitory storage medium of claim 17, further comprising selecting the placement node from among the candidate nodes based on at least the node scores of the candidate nodes.

19. The non-transitory storage medium of claim 11, further comprising migrating the workload from the placement load to a second node included in the nodes.

20. The non-transitory storage medium of claim 19, further comprising migrating the workload when the workload is moveable and the second node has a sufficient node score.
